(19) United States
(12) Patent Application Publication
(10) Pub. No.: US 2006/0048365 A1
(43) Pub. Date: Mar. 9, 2006

(54) Method of making an apertured disc and related product

(76) Inventor: David P. Bachelier, Pittsburgh, PA (US)

Correspondence Address: ECKERT SEAMANS CHERIN & MELLOTT, 600 GRANT STREET, 44TH FLOOR, PITTSBURGH, PA, 15219, US

(21) Appl. No.: 10/937,530

(22) Filed: Sep. 9, 2004

(51) Int. Cl. B23P 17/00; B21K 1/20

(52) U.S. Cl. 29/412; 29/888.41; 123/188.9

(57) ABSTRACT

A method of making an apertured disc, which may be a valve guide for fuel injection systems, includes providing an elongated metal strip, establishing a plurality of generally circular circumferentially spaced first openings of a first diameter, establishing chamfers in the upper and lower portions of the first openings and creating a central opening radially inwardly of the first openings followed by severing a disc containing the openings. The disc edges may be treated to produce a radiused edge. The method preferably involves a progressive stamping operation. A corresponding apertured disc is disclosed.

### BACKGROUND OF THE INVENTION

1. Field of the Invention

The present invention relates to a method of making an apertured metal disc, such as a valve guide for fuel injection systems, and more specifically, it relates to the making of the same by a progressive stamping operation employing chamfering and coining.

2. Description of the Prior Art

It has been known to make valve guides for fuel injection systems by starting with a stainless steel rod made, for example, of 440C stainless from which the guides are made by Swiss CNC machining as by using a precision screw machine.

There remains a very real and substantial need to provide an improved means for manufacturing such valve guides and a resultant product.

### SUMMARY OF THE INVENTION

The present invention has met the above-described need by providing a method of making an apertured disc which includes providing an elongated metal strip, establishing a plurality of generally circular circumferentially spaced first openings of the first diameter, chamfering or counterboring upper and lower portions of said first openings followed by repiercing the first openings to the desired size and creating a central opening smaller than the finished size disposed radially inwardly of the first openings followed by repiercing to finished size followed by creating chamfers on the upper and lower portions of the inside diameter of central opening.

The operation preferably includes a progressive stamping operation which produces a valve guide for fuel injection systems. Specific preferred chamfers are provided at the upper and lower extremities of the first openings as well as in the upper and lower portions of the central opening.

The resultant product has the desired construction with the first openings having chamfered portions at the upper and lower extremities thereof along with chamfering of the central opening at the lower and upper extremities.

It is an object of the present invention to provide an improved method and associated resultant product for making precision apertured discs by a progressive stamping operation.

It is a further object of the present invention to employ chamfering at predetermined locations in facilitating establishing the desired structure.

It is yet another object of the present invention to avoid the prior art methods which made such projects from a workpiece in rod form and required substantial machining.

These and other objects of the present invention will be more fully understood form the following detailed description of the invention on reference to the illustrations appended hereto.

### BRIEF DESCRIPTION OF THE DRAWINGS

FIG. 1 illustrates a front elevational view of a disc of the present invention.

FIG. 2 is a cross-sectional illustration of the disc taken through 2-2 of FIG. 1.

FIG. 3 is a perspective view of the disc of FIG. 1.

FIG. 4 is a schematic illustration of a preferred method of the present invention.

### DESCRIPTION OF THE PREFERRED EMBODIMENTS

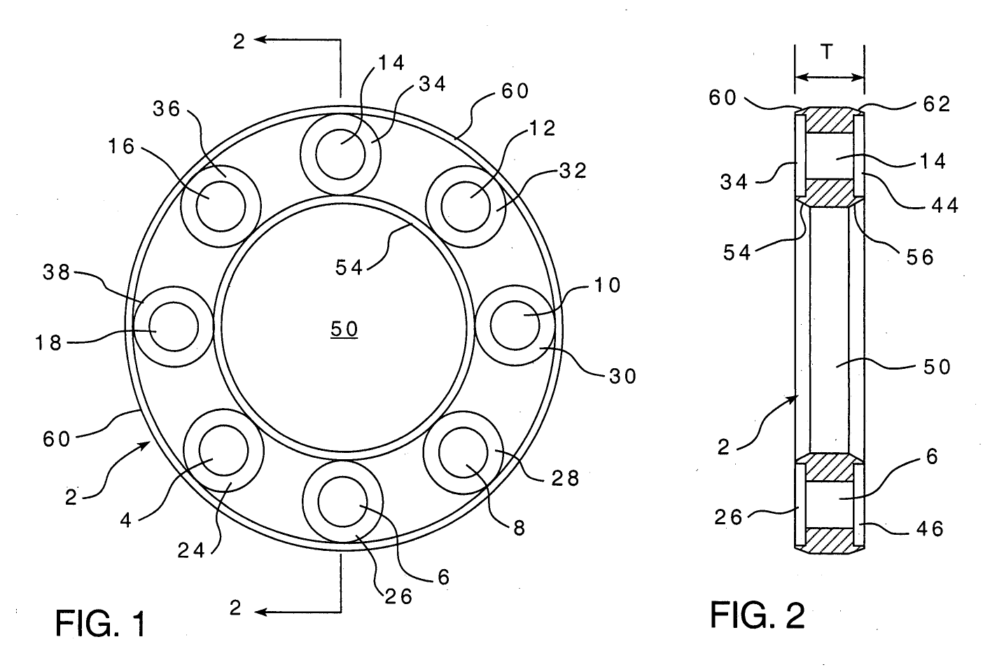

Referring to FIGS. 1 through 3 wherein the numerical dimensions are shown in millimeters, it will be seen that the disc of the present invention, which may be a valve guide for fuel injection systems, consists of a disc 2 having a plurality of first openings 4, 6, 8, 10, 12, 14, 16, 18 which have substantially the same diameter and are relatively circumferentially spaced from each other and in the form shown are eight in number. The adjacent pairs of first openings such as 12 and 14 in the form shown are offset from each other by about 45°. Each of the first openings 4, 6, 8, 10, 12, 14, 16, 18 has an upper annular chamfer 24, 26, 28, 30, 32, 34, 36, 38 and a corresponding lower chamfer such as 44, 46 as shown in FIG. 2. The upper chamfers 24, 26, 28, 30, 32, 34, 36, 38 may be formed simultaneously with the lower chamfers.

By way of specific example, the overall width of the disc 2 may be 0.75 mm and the depth of each chamfer 0.127 mm thereby creating an axial opening such as 14 with the total axial extent of both chamfers 34, 44 added together being substantially less than the thickness T of the disc and in the form shown less than one half the thickness T. In the preferred form, the first openings 4, 6, 8, 10, 12, 14, 16, 18 will have an internal diameter measured between the chamfered portions which is less than the thickness of the valve guide.

A central opening 50 may be created with annular chamfers 54, 56 provided at the upper and lower inner diameter edges of the central opening 50, if desired. Forming the upper and lower chamfered regions around the first openings 4, 6, 8, 10, 12, 14, 16, 18 establishes metal flow to reduce the size of openings 4, 6, 8, 10, 12, 14, 16, 18.

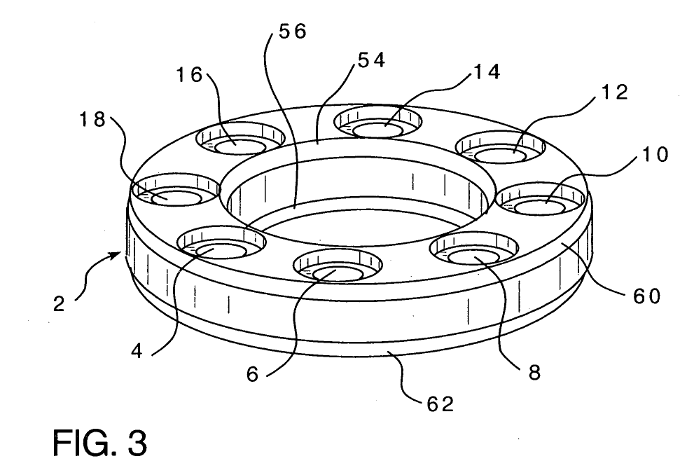

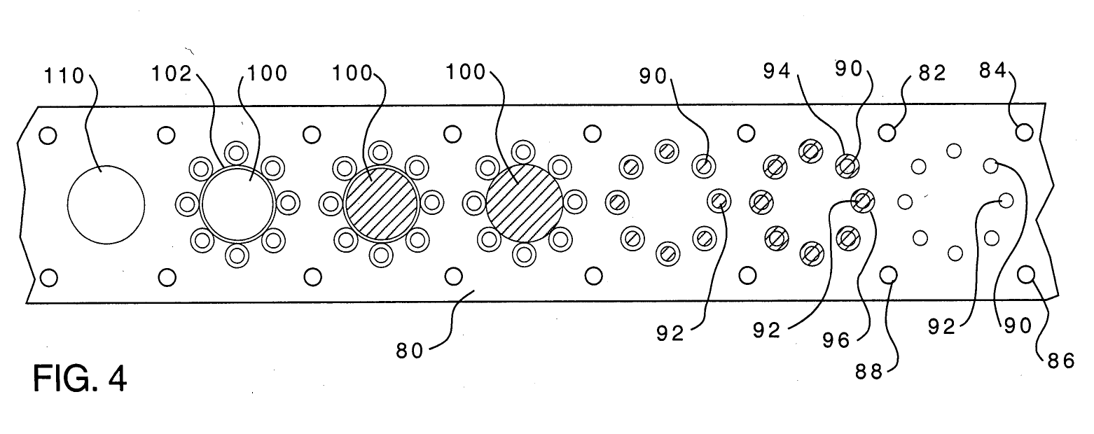

Referring to FIG. 4, there is shown a schematic diagram of a form of progressive stamping of a strip 80 to form the disc of FIGS. 1 through 3, for example. The parent stock has a plurality of indexing openings such as 82, 84, 86, 88, for example, to facilitate engaging the strip and moving the strip to the desired position. In Step 1, a plurality of first openings such as 90, 92 which ultimately will correspond to the first eight openings 4, 6, 8, 10, 12, 14, 16, 18 shown in FIGS. 1 and 3 are formed. In Step 2, the openings such as 90, 92 have been subjected to the creation of upper chamfers respectively 94, 96, for example, and lower chamfers (not shown). In the next stage, the openings such as 90, 92 are subjected to a shaving operation to eliminate the excess metal.

In Step 4, a central opening 100 corresponding to opening 50 is formed and in Step 5, the opening 100 is shaved to remove excess metal and to control final size and finish requirements. In Step 6, the Opening 100 is provided with an upper chamfer 102 and a corresponding lower chamfer (not shown). In Step 9, the disc has been removed from the sheet material 80 leaving opening 110. If desired, the disc may be tumbled in a suitable media well known to those skilled in the art in order to produce a radiused edge. In the alternative, coining may be employed for this purpose.

It will be appreciated that the method of the present invention and the associated resultant product permit an efficient use of a multiple stamping operation to provide precision apertured discs which are suitable for many uses such as valve guides for fuel injection systems.

Whereas particular embodiments of the invention have been described herein for purposes of illustration, it will be evident to those skilled in the art that numerous variations of the details may be made without departing from the invention as defined in the appended claims.

1. A method of making an apertured disc comprising
providing an elongated metal strip,
establishing a plurality of generally circumferentially spaced first openings of a first diameter in said strip,
establishing chamfers in upper and lower portions of said first openings,
creating a central opening generally radially inwardly of said first openings, and
severing a disc containing said first openings and said central opening from said strip.

2. The method of claim 1, including
establishing said first openings by stamping.

3. The method of claim 2, including
employing said method to create a valve guide for a fuel injection system.

4. The method of claim 2, including
said upper and lower chamfers being formed substantially simultaneously.

5. The method of claim 2, including
establishing said center opening by stamping.

6. The method of claim 2, including
severing said disc as a generally circular disc.

7. The method of claim 5, including
creating a radiused edge on said severed disc.

8. The method of claim 6, including
effecting said stamping in a progressive stamping operation having a plurality of die stations.

9. The method of claim 2, including
the total depth of both said upper chamfer and said lower chamfer on each said first opening being less than one half the thickness of said metal strip.

10. The method of claim 2, including
said first openings all having substantially the same diameter.

11. The method claim 2, including
establishing chamfers in the top and bottom of said central opening.

12. The method of claim 4, including
employing said method to create said valve guide which is generally identical in appearance when viewed from the top as viewed from the bottom.

13. The method of claim 1, including
after forming said first openings shaving them to remove excess metal therefrom.

14. The method of claim 1, including
after forming said central opening shaving said opening to remove excess metal therefrom.

15. The method of claim 1, including
employing stainless steel as said metal.

16. A metal valve guide for fuel injection systems comprising
a valve guide body having a central opening and a plurality of circumferentially spaced fuel openings disposed generally radially outwardly of said central openings, and
said fuel openings having upper and lower chamfered portions.

17. The valve guide of claim 16, including
said valve guide having a radiused edge disposed radially outwardly of said fuel openings.

18. The valve guide of claim 16, including
said fuel openings having an internal diameter measured between said chamfered portions less than the thickness of said valve guide.

19. The valve guide of claim 16, including
the axial extent of the combined chamfers of a said first opening being less than one half the axial extent of said fuel opening.

20. The valve guide of claim 16, including
said central opening having chamfered upper and lower portions.

21. The valve guide of claim 19, including
said valve guide being composed of stainless steel.
